(19) United States
(12) Patent Application Publication
(10) Pub. No.: US 2003/0174423 A1
(43) Pub. Date: Sep. 18, 2003

(54) Monolithic filter array

(76) Inventors: Brian T. Hart, Painted Post, NY (US); Michael J. Yadlowsky, Corning, NY (US); George F. Wildeman, Painted Post, NY (US)

Correspondence Address: VOLENTINE FRANCOS, PLLC, SUITE 150, 12200 SUNRISE VALLEY DRIVE, RESTON, VA, 20191, US

(21) Appl. No.: 10/099,089

(22) Filed: Mar. 15, 2002

(51) Int. Cl. G02B 5/20; G02B 6/28; G02B 5/22

(52) U.S. Cl. 359/889; 385/24

(57) ABSTRACT

According to an exemplary embodiment of the present invention, an optical apparatus includes a monolithic optical filter array haiving a first optical filter element. The monolithic optical filter array also includes a second optical filter element proximate to the first optical filter element. The second optical filter element is detuned relative to the first optical filter element.

According to another exemplary embodiment of the present invention, an optical apparatus includes an input port. The optical apparatus further includes a monolithic optical filter array having at least one column comprising a nominal optical filter element, and at least a detuned filter element. The apparatus also includes a device for aligning the input port to a desired one optical filter of the monolithic optical filter array.

According to another exemplary embodiment of the present invention, a method of extracting light of a particular wavelength includes providing a monolithic optical filter array having at least one column which includes a nominal wavelength optical filter element and a detuned wavelength optical filter element. The method further includes providing an input port proximate to the optical filter array, and aligning the input port to a desired one of the optical filter elements of the monolithic optical filter array.

### CROSS-REFERENCE TO RELATED APPLICATIONS

The present application is related to U.S. patent application Ser. Nos. (Attorney Docket Nos.: CRNG.031 and CRNG.033) entitled “Optical Filter Array and Method of Use” and “Tunable Optical Filter Array and Method of Use,” respectively, and filed on even date herewith. The inventions of these applications are assigned to the assignee of the present invention, and the disclosures of these applications are incorporated by references herein and for all purposes.

### FIELD OF THE INVENTION

The present invention relates generally to optical communications, and particularly to a monolithic optical filter array.

### BACKGROUND OF THE INVENTION

Optical transmission systems, including optical fiber communication systems, have become an attractive alternative for carrying voice and data at high speeds. In addition to the pressure to improve the performance of optical communication systems, there is also increasing pressure on each segment of the optical communication industry to reduce costs associated with building and maintaining an optical network.

One technology used in optical communication systems is wavelength division multiplexing (WDM). As is well known, WDM pertains to the transmission of multiple signals (in this case optical signals) at different wavelengths down a single waveguide, providing high-channel capacity. Typically, the optical waveguide is an optical fiber.

One technology used in optical communication systems is wavelength division multiplexing (WDM). As is well known, WDM pertains to the transmission of multiple signals (in this case optical signals) at different wavelengths down a single waveguide, providing high-channel capacity. Typically, the optical waveguide is an optical fiber.

For purposes of illustration, according to one International Telecommunications Union (ITU) grid a wavelength band from 1530 nm to 1565 nm is divided up into a plurality of wavelength channels, each of which have a prescribed center wavelength and a prescribed channel bandwidth; and the spacing between the channels is prescribed by the ITU grid. For example, one ITU channel grid has a channel spacing requirement of 100 GHz (in this case the channel spacing is referred to as frequency spacing), which corresponds to channel center wavelength spacing of 0.8 nm. With 100 GHz channels spacing, channel “n” would have a center frequency 100 GHz less than channel “n+1” (or channel n would have a center wavelength 0.8 nm greater than channel n+1). The chosen channel spacing may result in 40, 80, 100, or more wavelength channels across a particular passband.

While the use of Bragg gratings and optical filters based on other technologies has shown promise from the perspective of performance and versatility in optical communication systems, there exist certain drawbacks in the known art. For example, the fabrication of an array of optical filters can be significantly hindered by a slight offset in the periodicity of the optical grating during manufacturing. This can result in a significantly reduced yield, and an overall increase in the cost of the final product.

What is needed, therefore, is an optical filter array which overcomes at least the drawbacks of conventional methods and apparati described above.

### SUMMARY OF THE INVENTION

According to an exemplary embodiment of the present invention, an optical apparatus includes a monolithic optical filter array having a first optical filter element. The monolithic optical filter array also includes a second optical filter element proximate to the first optical filter element. The second optical filter element is detuned relative to the first optical filter element.

According to another exemplary embodiment of the present invention, an optical apparatus includes an input port. The optical apparatus further includes a monolithic optical filter array having at least one column comprising a nominal optical filter element, and at least a detuned filter element. The apparatus also includes a device for aligning the input port to a desired one optical filter of the monolithic optical filter array.

According to another exemplary embodiment of the present invention, a method of extracting light of a particular wavelength includes providing a monolithic optical filter array having at least one column which includes a nominal wavelength optical filter element and a detuned wavelength optical filter element. The method further includes providing an input port proximate to the optical filter array, and aligning the input port to a desired one of the optical filter elements of the monolithic optical filter array.

### BRIEF DESCRIPTION OF THE DRAWINGS

The invention is best understood from the following detailed description when read with the accompanying drawing figures. It is emphasized that the various features are not necessarily drawn to scale. In fact, the dimensions may be arbitrarily increased or decreased for clarity of discussion.

FIG. 1 is a perspective view of an optical filter array of nominal and detuned optical filter elements in accordance with an exemplary embodiment of the present invention.

FIG. 2 is a graphical representation of the frequency response of optical filters showing channel spacing and detuning spacing in accordance with an exemplary embodiment of the present invention.

FIG. 3 is a two-port reconfigurable tunable filter array in accordance with an exemplary embodiment of the present invention.

FIG. 4 is a stacked optical array in accordance with an exemplary embodiment of the present invention.

FIG. 5 is a serial array of optical filters in accordance with an exemplary embodiment of the present invention.

### DEFINED TERM

As used herein the term “monolithic optical filter array” pertains to a plurality of optical filter elements formed in a common substrate.

### DETAILED DESCRIPTION

In the following detailed description, for purposes of explanation and not limitation, exemplary embodiments disclosing specific details are set forth in order to provide a thorough understanding of the present invention. However, it will be apparent to one having ordinary skill in the art having had the benefit of the present disclosure, that the present invention may be practiced in other embodiments that depart from the specific details disclosed herein. Moreover, descriptions of well-known devices, methods and materials may be omitted so as to not obscure the description of the present invention.

Briefly, the present invention is drawn to a monolithic optical filter array, an apparatus including the monolithic optical filter array and its method of use, wherein the filter array is an array of optical filter elements.

In accordance with an exemplary embodiment of the present invention, the monolithic optical filter array comprises a single row of nominal filters designed for the extraction of desired frequencies/wavelengths from an incoming optical signal which includes a plurality of frequencies/wavelengths. For example, the optical signal may be a WDM optical signal having n-wavelength channels with respective center wavelengths λ₁, . . . , λₙ. To relax manufacturing accuracy, as well as to accommodate shifts in the transmission wavelengths of an optical emitter used in the WDM system, proximate to this row of nominal optical filter elements is one or more rows of optical filter elements that are detuned from the center wavelengths by some small but finite amount.

In a deployed optical communication system, input and output optical couplers may be selectively aligned to a particular filter element for the extraction of a desired wavelength. Illustratively, if it is desired to extract another wavelength channel, the input and output couplers would be moved to the appropriate filter. If the resonant wavelength of a particular nominal optical filter element does not match the frequency to be extracted due to some manufacturing defect or shift in wavelength of the transmitter, a positively or negatively detuned filter element may then be selected (as appropriate) to extract the desired wavelength band.

As will become more clear as the present invention proceeds, the optical filters in accordance with exemplary embodiments of the present invention may be reflective-type filters, transmissive-type filters or a combination of different reflection-type filters and/or transmissive-type filters.

It is noted that for purposes of facility of discussion, the disclosure of the present invention will focus on reflective-type filters, although it is to be understood that transmissive-type filters may be used as well. A salient feature of the optical filters in accordance with exemplary embodiments of the present invention is the capability of monolithic fabrication using various materials.

It is further noted (again for clarity of discussion) that the present disclosure focuses primarily on the use of optical filters of the present invention in multiplexing/demultiplexing applications in optical communication systems. However, the optical filter array of the present invention have utility in a variety of other applications.

For example, the monolithic optical filter arrays according to an exemplary embodiment of the present invention could be used in EDFA applications where the amplifier operates over a relatively wide bandwidth. Illustratively, the tuneable optical filters of an exemplary embodiment of the present may be used to reject ASE from EDFA's, particularly pre-amplified receivers.

Additionally, the inventive optical apparatus may be deployed to filter out ASE in a deployed laser. As is known, as the wavelength of a laser drifts over time and temperature, it is necessary to change the filter to match the wavelength of the laser. This synchronization is needed for long periods of time in deployed systems. An implementation of an optical apparatus of an embodiment of the invention enables the synchronization to be readily achieved.

It is further noted that the above examples of the utility of the monolithic optical filter arrays of the present invention are merely illustrative of the present invention, and are intended to be in no way limiting. Clearly, other implementations of the monolithic optical filter array will be readily apparent to one of ordinary skill in the art who has had the benefit of applicants' disclosure.

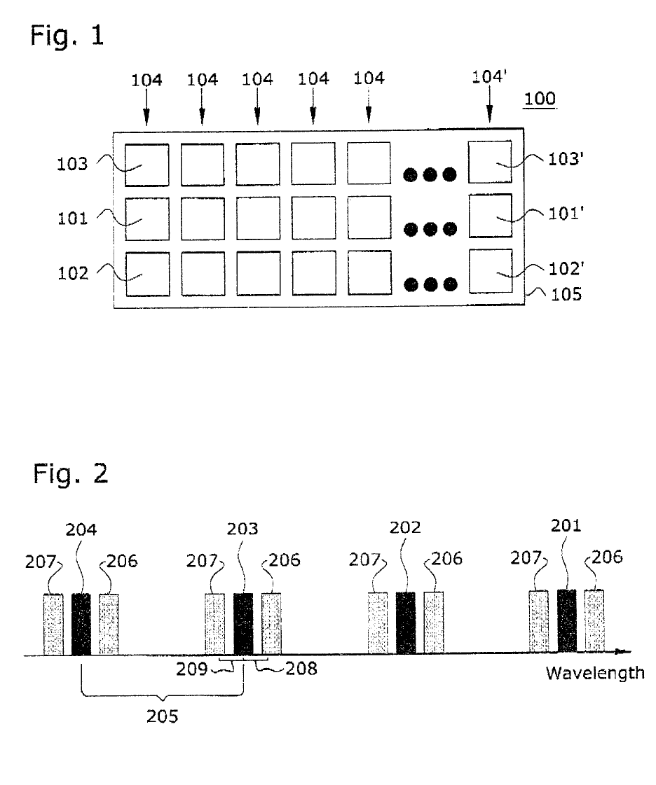

FIG. 1 shows a monolithic optical filter array 100 of nominal and detuned optical filter elements in accordance with an exemplary embodiment of the present invention. Nominal wavelength optical filter elements 101 are illustratively shown in a first row in the array. In the present exemplary embodiment negatively detuned wavelength optical filter elements 102 are shown in a second row of the array; and positively detuned wavelength optical filter elements 103 are shown in a third row in the array. In the exemplary embodiment presently described, each of the nominal wavelength optical filter elements 101 is designed to extract a particular wavelength channel.

Illustratively, the nominal and detuned wavelength optical filter elements 101, 102 and 103 are Bragg gratings. For example, the nominal and detuned wavelength optical filter elements 101, 102 and 103 may be Bragg gratings such as those described in detail in U.S. patent application Ser. No. 09/874,721, entitled “Bulk Internal Bragg Gratings and Optical Devices,” to Bhagavatula, et al., and filed on Jun. 5, 2001. Moreover, the substrate 105 in which the optical filter elements are monolithically formed to form the monolithic optical filter array 100 may be a glass material such as those taught in U.S. patent application Ser. No. 09/874,352, entitled “UV Photosensitive Melted Germano-Silicate Glass,” to Borrelli, et al., and filed on Jun. 5, 2001; or may be one of the glass material as taught in U.S. patent application Ser. No. (Attorney Docket No.: CRNG.034/SP01-222A) and entitled “Photosensitive UV Glasses” to Nicholas Borrelli, et al, filed on even date herewith. The inventions described in the above referenced U.S. Patent Applications are assigned to the Assignee of the present invention, and the disclosures of these applications are specifically incorporated by reference herein and for all purposes.

It is noted that there are advantageous characteristics of the glass monolithic optical filter elements 101-103 in accordance with the presently described exemplary embodiments that are described in the above referenced application entitled “Optical Filter Array and Method of Use.” Further details of such advantageous characteristics are found therein.

It is further noted that the above referenced gratings and materials are intended to be illustrative of and in no way limiting of the scope of the present invention. To wit, other materials to include polymers, such as fluorinated acrylate; porous glass, such as doped porous glasses which are consolidated at a relatively high temperature; and dichromated gelatin may be used as the substrate in which optical filter elements 101, 102 and 103 maybe formed.

Moreover, the use of Bragg gratings as nominal and detuned wavelength optical filter elements 101, 102, and 103 are illustrative. It is noted that other interferometric filters such as holographic filters and guided mode resonance (GMR) filters may be used as nominal wavelength optical filter elements 101, 102 and 103. In general, gratings that may be written in the substrate using interference effects or phase masks to form the optical filter elements of the monolithic optical filter array 100 may be used in carrying out the present invention. Moreover, other types of filters may be used including, but not limited to micro-electromechanical (MEM's) optical filter elements. Finally, it is conceivable that the nominal and detuned wavelength optical filter elements 101, 102 and 103 are not based on the same filter technology; but rather on a combination of technologies.

In accordance with the exemplary embodiment of the present invention shown in FIG. 1, the monolithic optical filter array 100 includes columns 104 of filter elements. Each column 104 comprises a nominal wavelength optical filter element 101, a negatively detuned wavelength optical filter element 102 proximate the nominal wavelength optical filter element 101, and a positively detuned nominal wavelength optical filter element 103 also proximate the nominal wavelength nominal optical filter element 101.

In the presently described exemplary embodiment in which the monolithic optical filter array is used in a WDM application, each nominal wavelength optical filter element will reflect one wavelength channel having a particular center wavelength and bandwidth and will transmit all other wavelength channels. For purposes of illustration an n^{th} nominal filter element 101′ reflects an n^{th} wavelength channel incident thereon having a center wavelength of λₙ from a WDM/DWDM input signal, and will transmit wavelength channels 1, . . . , n−1, having respective center wavelength λ₁ , . . . , λₙ₋₁ therethrough.

Each of the positively and negatively detuned wavelength optical filter elements (102 and 103) of each column 104 reflects a wavelength band which has a center wavelength that is slightly offset relative to that of its proximate nominal wavelength filter. For example, in the exemplary embodiment shown in FIG. 1, column 104′ has a positively detuned optical filter element 103′ and a negatively detuned optical filter 102′. As referenced above, nominal filter element 101′ reflects wavelength channel n having a center wavelength λₙ. As such, the positively detuned optical filter element will reflect a wavelength band having center wavelength of λₙ+Δλ. Likewise, negatively detuned optical filter element 102′ will reflect a wavelength band having a center wavelength of λₙ−Δλ. In the presently described exemplary embodiment, the 2 dB wavelength bandwidth is illustratively 0.24 nm (i.e., approximately 30 GHz), and the wavelength offset, Δλ, is illustratively 0.08 nm (i.e. approximately 10 GHz).

As will become more clear as the present description proceeds, it is noted that the offset, Δλ, between a nominal filter element 101, and the detuned optical filter elements 102 and 103 of a particular column 104 is significantly less than the difference between the center wavelength, which are reflected by two adjacent nominal optical filter elements 101. For example, in the exemplary embodiment shown in FIG. 1, the wavelength offset, Δλ, between nominal optical filter 101′ which reflects channel n having a center wavelength λₙ, and the differential between the center wavelength λₙ₋₁ of wavelength channel n−1 which is illustratively reflected by the nominal optical filter element 101 adjacent nominal optical filter element 101′ is significantly less.

Fabrication of the nominal and detuned wavelength optical filter elements 101, 102 and 103, regardless of the particular filter technology chosen or material used for substrate 105, is illustratively carried out monolithically. Again, further details of the fabrication as well as the materials used may be found in the above referenced applications to Bhagavatula, et al, and Borrelli, et al., respectively. Beneficially, this fosters practical manufacturing and reduced cost when compared to conventional fabrication techniques. For example, in the fabrication of gratings such as Bragg gratings or holographic gratings, a plurality of masks could be used to fabricate the fixed frequency filters 101, 102 and 103, with each mask tailored to fabricate a grating of a desired periodicity. Alternatively, a single phase mask could be used and the periodicity of each grating could be tailored by altering the angle of incidence of the grating and/or light source. Moreover, other interferometric techniques known to one of ordinary skill in the art may be used. Finally, it is noted that a combination of the illustrative fabrication techniques described immediately above could be used in fabricating the nominal wavelength optical filter elements 101, 102 and 103.

It is further noted that the present invention as described in connection with the exemplary embodiment would benefit the task of accommodating any wavelength shift due to time, temperature, or tuning of an EDFA or laser device.

From the above description surrounding column 104′, in the presently described exemplary embodiment it is clear that the other columns 104 each have a nominal optical filter element 101 and detuned optical filter elements 102 and 103 in proximity thereto. However, this arrangement is not essential to carrying out the present invention. To this end, depending upon the desired application, it may be useful to arrange the various optical filter elements 101, 102 and 103 to tailor a need. For example, it may be that there are a few nominal wavelength optical filter elements 101 surrounded by a plurality of detuned wavelength optical filter elements 102 and 103 of varying degrees. Moreover, it may be useful to have all of the detuned optical filter elements are positively detuned; or all are negatively detuned. Still other variations are possible, all of which are readily fabricated by virtue of the ease of manufacture afforded by the above referenced fabrication process.

FIG. 2 shows the frequency spacing for nominal and detuned filter elements according to an illustrative embodiment of the present invention. To this end, the wavelength channel passbands 201, 202, 203 and 204 correspond to the reflected wavelength channels of four nominal wavelength optical filter elements in accordance with an exemplary embodiment of the present invention. Likewise, the passbands 206 represent the wavelength passbands of the positively detuned optical filter elements in accordance with an exemplary embodiment of the present invention; and passbands 207 represent the wavelength passbands of negatively detuned optical filter elements in accordance with an exemplary embodiment of the present invention.

Focusing discussion momentarily on wavelength channel passbands 203 and 204, it can be readily appreciated from FIG. 2 that the spacing 205 between passbands 203 and 204 is significantly greater than the spacing 208 between the passbands of the positively detuned wavelength optical filter element and the spacing 209 between the passband 203 and the passband 207 of the negatively detuned wavelength optical filter element. For purposes of illustration and certainly not limitation, in accordance with an exemplary embodiment of the present invention, the spacing 205 between passbands 203 and 204 of nominal optical filters could correspond to the channel spacing of a WDM system. This channel spacing is illustratively 0.8 nm, although it could be other frequency spacing such as are prescribed by the International Telecommunication Union (ITU) grids. In the exemplary embodiment in which the spacing 205 is on the order of 0.8 nm, the spacings 208 and 209, are on the order of approximately 0.16 nm.

As will become more clear as the present description proceeds, if it is desired to extract a wavelength channel passband 203 in a demultiplexing application, a channel input comprising a plurality of optical channels would be aligned to the particular nominal wavelength optical filter element having the wavelength passband 203. An output would be suitably aligned so that wavelength passband 203 could be extracted from the plurality of frequencies of the channels.

Illustratively, wavelength passband 203 corresponds to a particular wavelength channel. Naturally, in accordance with exemplary embodiment of the present invention, tolerances as well as amplifier tuning and laser offset could result in the center wavelength of the particular desired channel being shifted to have a wavelength band corresponding to passband 206, or corresponding to passband 207. Alignment of the input and output devices to the particular detuned wavelength optical filter element would enable the extraction of the desired frequency/wavelength channel.

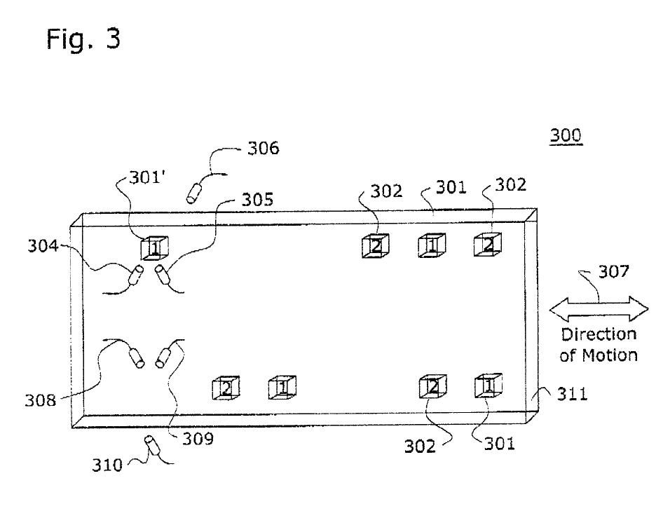

FIG. 3 shows a monolithic optical filter array 300 for use as a two-port reconfigurable tunable filter in accordance with an exemplary embodiment of the present invention. Practical applications of such a device include demultiplexing of desired multiplexed channels in a WDM system and adding/dropping channels in such a system. The monolithic optical filter array 300 includes a substrate 311 which is of material in keeping with the materials described previously. A plurality of optical filter elements 301 are used to extract a first wavelength channel having a first center wavelength, and second optical filter elements 302 are used to extract a second wavelength channel having a second center wavelength. It is noted that for purposed of clarity of discussion, the first optical filter elements 301 and second optical filter elements 302 may be either the nominal wavelength optical filter elements, or the positively or negatively detuned wavelength optical filter elements as described previously. It is further noted that in accordance with the exemplary embodiment shown in FIG. 3, the nominal, positively detuned, and negatively detuned wavelength filters are monolithically formed on the substrate as previously described.

In accordance with the exemplary embodiment shown in FIG. 3, an input 304 is aligned with one of the first optical filter elements 301. The input illustratively includes a plurality of multiplexed optical signals such as those of a standard WDM optical system. A first optical filter element 301′ is illustratively a nominal wavelength filter element that reflects a wavelength channel having a first center wavelength. This reflected signal is incident upon the output 305. All other wavelength channels of the WDM signal from input 304 are transmitted through to the output 306.

If it is desired to extract another wavelength channel of the WDM signal, a number of options are available according to the exemplary embodiment of the present invention. First, simple translational motion such as shown at 307 enables the alignment of the input 304, outputs 305 and 306 to another of the first optical filter elements 301 and 302. For example, it may be desired to extract the second wavelength channel through the use of one of the second optical filter elements 302. This is carried out in accordance with an exemplary embodiment of the present invention using a second input 308 which may be aligned to one of the second optical filter elements 302. The extracted wavelength channel having the second frequency is output to output 309, and the remaining WDM channels are output to the other output 310.

Accordingly, the relative motion of the monolithic optical filter array 300 and the inputs and outputs enables the chosen alignment of a particular input to a particular fixed-frequency filter. It is noted that the exemplary embodiment as shown in FIG. 3 can be readily expanded and/or modified. To this end, the array 300 could include a plurality of filters, each designed to reflect a particular wavelength channel center frequency. It is further noted that the array 300 could include the nominal and positively and negatively detuned filters for all channels in a particular passband. As such, there could be 40, 80 or 100 nominal filter elements each having respective detuned elements proximate thereto.

To effect the extraction of a particular wavelength channel, the relative motion of the array can be carried out properly align the input and output ports to a particular fixed-frequency filter. This may be readily carried out by filter control circuitry (not shown) which incorporates a look-up table to recall the position of a filter element which reflects a desired frequency. Moreover, the look-up table can retain the nominal, positively detuned, or negatively detuned filter elements chosen at a particular time of calibration to be used for each channel setting. As such, if a particular filter does not reflect the required wavelength channel due to a manufacturing defect or drifting of the optical emitter of the system, alignment of the input and output ports can be effected via the look-up table and filter control circuitry. Further details of the structure and electronics for carrying out this relative motion may be found in the above captioned application entitled “Optical Filter Array and Method of Use.”

It is noted that in the illustrative embodiments described thus far, the optical filter elements are contiguously arranged. It is noted that it is not required that the optical filter elements be distributed contiguously. To this end, all elements, nominal optical filters as well as positively and negatively detuned optical filter elements may be written in a single linear array in any order. To wit, it is not required that the progression of resonant wavelengths/frequency be sequential, as the look-up table and filter control circuitry can be readily modified to accurately determine the position of a particular filter, regardless if its particular resonant wavelength/frequency is sequential in the optical filter array. This enables the user to tailor a particular system for a particular intended use. Moreover, errors in manufacturing can be readily mitigated. To this end, if there is an error in the fabrication of a particular filter causing a break in a particular filter sequence, the filter array would not be lost to scrap. Instead, a slight modification in a look-up table can account for the break in the sequence. Finally, the arrays described have been rectangular with regular rows and columns. However, this is not essential. For example, circular or elliptical arrangements of filters may be effected in keeping with the present invention.

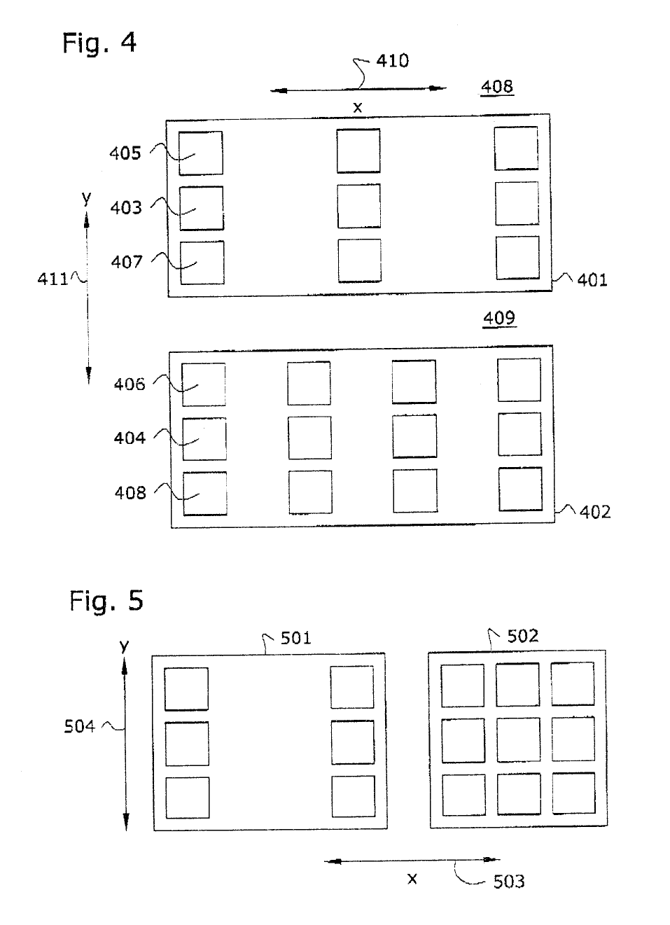

FIGS. 4 and 5 show stacked and serial filters arrays, respectively, in accordance with exemplary embodiments of the present invention. The NxM optical filter arrays may be as described in the above captioned application entitled “Optical Filter Array and Method of Use.” A first substrate 401 and a second substrate 402 have a plurality of nominal filter elements 403 and 404, respectively. Positively detuned elements 405 and 406, as well as negatively detuned elements 407 and 408 complete the array. The stacked nature of the first and second arrays 408 and 409 of the illustrative embodiment shown in FIG. 4 enables a reduction in the complexity of fabrication. To wit, by fabricating a particular array to reflect a first number of wavelength channels and another array to reflect another number of wavelength channels, a full passband can be accommodated, but with less complexity in fabrication. In accordance with the exemplary embodiment shown in FIG. 4, it is merely necessary to have the capability of aligning input and output ports by motion in the x-direction (410) as well as in the y-direction (411). Again, a look-up table and filter control circuitry would be used to guide the input and output ports to a particular filter so that a desired wavelength could be extracted. Similarly, as shown in FIG. 5, a first array 501 and a second array 502 could be fabricated and motion in the x-direction (503) and y-direction (504) enables the alignment to any of the elements of either array. Finally, it is noted that the NxM optical filter arrays may be accessed using one-dimensional motion, using a method described in the above captioned application entitled “Optical Filter Array and Method of Use.” Further details may be found therein.

The invention having been described in detail in connection through a discussion of exemplary embodiments, it is clear that modifications of the invention will be apparent to one having ordinary skill in the art having had the benefit of the present disclosure. Such modifications and variations are included in the scope of the appended claims.

We claim:

1. An optical apparatus, comprising:
a monolithic optical filter array which includes a first optical filter element, and a second optical filter element proximate to the first optical filter element, wherein said second optical filter element is detuned relative to said first optical filter element.

2. An optical apparatus as recited in claim 1, further comprising a third optical filter element proximate to said first optical filter element, and which is detuned relative to said first optical filter element.

3. An optical apparatus as recited in claim 1, wherein said second optical filter element is positively detuned relative to said first optical filter element.

4. An optical apparatus as recited in claim 2, wherein said third optical filter element is negatively detuned relative to said first optical filter element.

5. An optical apparatus as recited in claim 2, wherein a fourth optical filter element is disposed proximate to said first optical filter element, and said first and said fourth optical filter elements are nominal wavelength optical filter elements.

6. An optical apparatus as recited in claim 5, wherein said first, said second, said third, and said fourth optical filter elements are chosen from the group consisting essentially of: Bragg gratings; holographic gratings; guided mode resonance filters; micro-electromechanical filters; and guided mode resonance filters.

7. An optical apparatus as recited in claim 2, wherein a plurality of said first optical filter elements forms a first row, a plurality of said second optical filter elements forms a second row, and a plurality of said third optical filter elements forms a third row.

8. An optical apparatus as recited in claim 7, wherein said monolithic optical filter array further includes a plurality of columns, and each of said columns includes one of said first optical filter elements, one of said second optical filter elements, and one of said third optical filter elements.

9. An optical apparatus as recited in claim 8, wherein each of said first optical filter elements of said rows is a nominal wavelength filter element.

10. An optical apparatus as recited in claim 8, wherein each of said second optical filter elements is a positively detuned wavelength optical filter element.

11. An optical apparatus as recited in claim 8, wherein each of said second optical filter elements of said columns is a negatively detuned wavelength optical filter element.

12. An optical apparatus, comprising:
a monolithic optical filter array which includes at least one column comprising a nominal wavelength optical filter element and a detuned wavelength optical filter element;
an input port proximate to said monolithic optical filter array; and
a device for aligning said input port to a desired one of said optical filter elements of said monolithic optical filter array.

13. An optical apparatus as recited in claim 12, further comprising another detuned wavelength optical filter element in said at least one column.

14. An optical apparatus as recited in claim 12, further comprising a plurality of said columns.

15. An optical apparatus as recited in claim 13, further comprising a plurality of said columns.

16. An optical apparatus as recited in claim 13, wherein said detuned wavelength optical filter element is positively detuned, and said another detuned wavelength optical filter element is negatively detuned.

17. An optical apparatus as recited in claim 14, wherein said monolithic optical filter array further comprises N rows and M columns, and wherein one of said N rows comprises a plurality of said nominal wavelength optical filter elements.

18. An optical apparatus as recited in claim 17, wherein one of said N rows further comprises a plurality of said detuned optical filter elements.

19. An optical apparatus as recited in claim 17, wherein one of said N rows further comprises a plurality of said another detuned wavelength optical filter elements.

20. An optical apparatus as recited in claim 12, further comprising an output port which is also aligned to a desired one of said optical filter elements by said device.

21. A method of extracting light of a particular wavelength, comprising:
providing a monolithic optical filter array having at least one column which includes a nominal wavelength optical filter element and a detuned optical filter element;
providing an input port proximate to said optical filter array; and
aligning said input port to a desired one of said optical filter elements of said monolithic optical filter array.

22. A method as recited in claim 21, further comprising: providing another detuned wavelength optical filter element in said at least one column.

23. A method as recited in claim 21, further comprising a plurality of said columns.

24. A method as recited in claim 22, further comprising a plurality of said columns.

25. A method as recited in claim 22, wherein said detuned wavelength optical filter element is positively detuned, and said another detuned wavelength optical filter element is negatively detuned.

26. A method as recited in claim 23, wherein said monolithic optical filter array further comprises N rows and M columns, wherein one of said N rows comprises a plurality of said nominal wavelength optical filter elements.

27. A method as recited in claim 26, wherein one of said N rows further comprises a plurality of said detuned optical filter elements.

28. A method as recited in claim 26, wherein one of said N rows further comprises a plurality of said another detuned optical filter elements.

29. A method as recited in claim 21, further comprising providing an output port proximate to said optical filter array; and
aligning said output to a desired one of said optical filter elements of said monolithic optical filter array.
